(19) United States
(12) Patent Application Publication
(10) Pub. No.: US 2024/0208164 A1
(43) Pub. Date: Jun. 27, 2024

(54) Textured Approach for Joining a Fiber Reinforced Polymer (FRP) to a Base Material

(71) Applicant: KTH Parts Industries Inc., St. Paris, OH (US)

(72) Inventor: Anoop SAMANT, Dublin, OH (US)

(21) Appl. No.: 18/145,152

(22) Filed: Dec. 22, 2022

(51) Int. Cl. B29C 70/54; B29C 59/02

(52) U.S. Cl. CPC B29C 70/547; B29C 59/02

(57) ABSTRACT

A texture is provided on a base material to assist flow of polymer matrix material from the fiber reinforced polymer into the base material. The textured surface may include a pattern of features such as knurls, depressions, ridges, asperities, cross-hatches, parallel or non-parallel lines, star shapes, triangles, hexagons, etc. The texture can be on one or both surfaces of the base material. The texture may be imprinted into the base material via, for example squeezing, machining, pressing, forming, knurling, stamping, etching, forging, cutting, rolling, or other imprinting processes.

### FIELD

The field of this invention pertains to joining of fiber reinforced polymer (FRP) to base materials. More specifically, the field of this invention pertains to the joining of two materials by creating a texture on the base material surface, melting polymer from the FRP and allowing the melted polymer to flow into the textures, and cooling the polymer to a solid state to join the FRP to the base material.

### BACKGROUND

The increasing use of FRPs as a lightweight material in different industries such as automotive, aerospace, marine, and powered mobility requires more effective and reliable joining techniques. Adhesives is one of the commonly used methods for joining FRPs to material surfaces. The FRPs contain chemicals such as mold release agents and contaminants which require removal prior to adhesive bonding. Hence surface treatment is an extremely important step governing the quality of adhesive bonded joints.

Commonly used surface preparation methods leave a resin rich surface layer on the composite which is prone to nucleation of cracks and may have an impact on the structural integrity of the joint. Several unique methods such as laser texturing are sometimes used to modify the surfaces (see, for example, U.S. Pat. No. 10,082,166 B2) and the two surfaces are then joined together by adhesives. In some methods, holes are used to connect metal to FRPs (see, for example, international publication number WO 2012/105415) but this method also requires the application of adhesives, which in general is not a very environmentally friendly process due to release of contaminants in air, water, and soil.

Injection molding has been used to join multiple sheets of materials with adhesives by creating three-dimensional protrusions on one of the material sheets through chemical etching (see, for example, U.S. Pat. No. 8,696,923 B2). This approach has been used to join two aluminum plated steel sheets, or an aluminum-plated steel sheet and another metal part, or an aluminum-plated steel sheet and FRP. However, this method also requires adhesives which leads to issues mentioned earlier such as necessity of surface treatment and impact to environment.

Mechanical fasteners such as Self Piercing Rivets (SPR), Flow Drill Screws (FDS), and RivTac are also used to join the FRP to a base material. However, these processes mostly require surface preparation such as predrilled holes. In addition, these processes damage the fibers in the FRP and affect the joint performance. Also, fasteners add weight to the structure reducing the lightweight benefit from the FRP. Laser ablation has been used to create a pattern on the metal surface and the metal is joined to the FRP by welding (see, for example, patent number JP 6255523). However, this process requires a coaxially arranged rod electrode and a ring electrode pressed to the upper metal plate. Another method (U.S. Publication Number US 2018/0272619 A1) uses a hybrid shaping and energizing system having a shaping tool and an ultrasonic horn to join dissimilar materials. However, this method needs complex shaped tools for joining. Thus, there is a demand for advances and improvements to the methods and devices for joining FRPs to metals.

### SUMMARY

Disclosed is a system and method for joining dissimilar materials which overcomes at least some of the above described limitations of the prior art. Disclosed is a system and method that provides texture with a certain geometry for specific purposes. The presence of texture allows the matrix polymer material from the FRP to melt and flow into the texture and create a strong joint with the base material on solidification.

The texture is designed for the formation of a joint between a FRP layer and a base material, for example, formed of a metal, polymer, ceramic or any other material. The FRP and the base material may be in sheet form and have a planar surface or a curved surface. The texture is formed on a first surface of the base material and may have different geometries. The texture can either be machined or stamped into the first surface of the base material. Any other method could also be used to create the texture on the base material.

Also disclosed is a process for the formation of the product referred to as a laminate that can be used for different applications in different industries such as automotive, aerospace, marine, and powered mobility.

From the aforementioned disclosure, and subsequent detailed figures and descriptions of specific embodiments, it will be evident to those in the field of this disclosure that this invention provides a significant advance in the technology of systems and methods for joining FRP to base materials.

### BRIEF DESCRIPTION OF THE DRAWINGS

The below included figures are intended to illustrate certain aspects of the present disclosure, and should not be viewed or considered as exclusive embodiments of the present disclosure. The subject matter disclosed is capable of considerable modifications, alterations, combinations, and/or equivalents in form and function, without departing from the scope of this disclosure.

FIG. 1A is a schematic representation of a traditional joining operation using adhesives.

FIG. 1B is a flow chart representing traditional joining operation using adhesives shown in FIG. 1A.

FIGS. 2A, 2B, and 2C represent the different mechanical fasteners that are typically used to join FRP to a base material.

FIG. 3A is a schematic representation of the method of joining of FRP to base material and creating laminates by applying a texture on the base material.

FIG. 3B is a flow chart representing the method of joining of FRP to base material and creating laminates by applying a texture on the base material as shown in FIG. 3A.

FIG. 4 is an exemplary processing curve for a matrix material for the FRP.

FIG. 5 is a schematic representation of the matrix material from the FRP flowing into the texture on the base material.

FIGS. 6A, 6B, and 6C represent some of the different textures that could be possibly applied to the base material.

FIG. 7 is a microscopic cross section of a joint produced by method represented in FIG. 3A and FIG. 3B.

### DETAILED DESCRIPTION

The present disclosure is related to a textured surface on the base material and a method of using the same.

The base material can be metal, polymer, ceramic or any other material on which a texture could be applied

The FRPs can have any kind of polymer material as the matrix. Usually a synthetic resin is chosen as the matrix material but it could be any other material that meets desired performance requirements. The resin can be polypropylene (PP), polyamide6 (PA6), polycarbonate (PC), polyetheretherketone (PEEK), polyaryletherketone (PAEK), or any other polymer material that meets the requirements of a matrix material.

In addition to the matrix, the FRPs also have a second component which is embedded in and reinforces the matrix. The reinforcing agent can be carbon fibers or glass fibers or a mix of carbon and glass fibers.

Embodiments discussed herein describe improvements to the base material surface by providing a surface of the base material with a textured region or surface arranged on the surface of the base material in a specific pattern. The textured surface on either or both the material surfaces may have a texture including a plurality of knurls, depressions, ridges, asperities, cross-hatches, parallel or non-parallel lines, star shapes, triangles, hexagons, holes, channels or other features.

Embodiments discussed herein also describe the method of joining of FRP to base materials and creating laminates that can be used for any application. The presently disclosed embodiments provide a larger volume for the matrix from the FRPs to flow into the base material when melted and join with the base material once solidified. Different methods may be applied for melting and solidifying the matrix material. Such methods may include using a heated platen press to deliver a predetermined amount of heat for a predetermined amount of time and at a predetermined pressure. The press may be mechanical, hydraulic, pneumatic, etc. Any other method that can deliver a predetermined amount of heat for a predetermined amount of time and at a predetermined pressure to the matrix polymer can also be used.

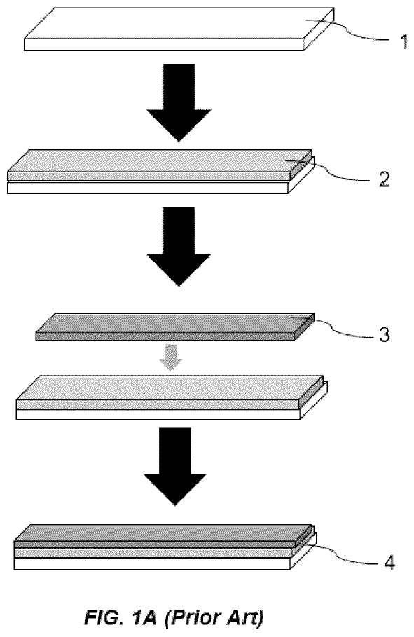

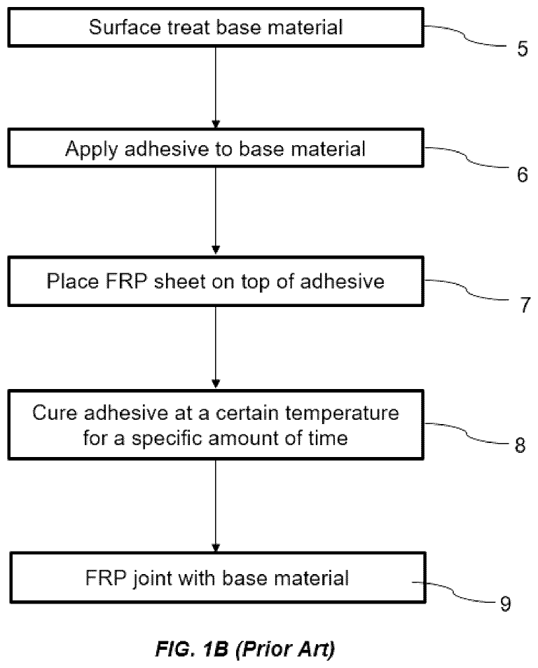

FIG. 1A illustrates an exemplary traditional joining operation using adhesives. After surface treating base material 1, adhesive 2 is applied to it. The FRP 3 is then placed on top of the adhesive. The assembly of base material 1, adhesive 2, and FRP 3 is then cured at a certain temperature for a specific amount of time to get the desired strength and the final joint 4 is created. The base material 1 and FRP 3 could be in the form of a sheet, tube or any other form. Each adhesive has its own curing time and temperature. FIG. 1B is a flowchart of the example showing process steps 5, 6, 7, 8, and 9.

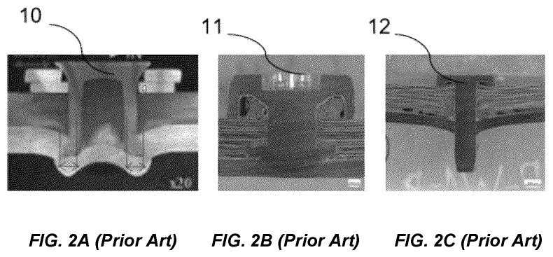

FIGS. 2A, 2B and 2C illustrate commonly used mechanical fasteners in state of the art for joining the FRP to the base material. 10 represents a joint developed by Self Piercing Rivet (SPR) in which a rivet is pushed through the material until it reaches the die on the bottom side where the legs flare out. 11 is a representation of a joint developed by Friction Element Welding (FEW) in which a rotating element of an umbrella shape penetrates the upper sheet and is friction welded onto the lower sheet, resulting in a form and force closure joint between the two sheets. 12 represents a joint developed by Flow Drill Screws (FDS) which uses the friction caused by the rotating screw to pierce and extrude the material. Threads are then created in this formed extrusion which allows the fastener to be screw driven into the material. A final torque then securely clamps together the sheets of material. These are just a few exemplary illustrations of the commonly used mechanical fasteners but other methods that create a successful joint between the two materials are also used. Other types of fasteners that can successfully meet the joint requirements are also used. Typically, these processes require some kind of surface preparation such as predrilled holes. Also, these processes damage the fibers in the FRP and have a negative impact on the joint quality.

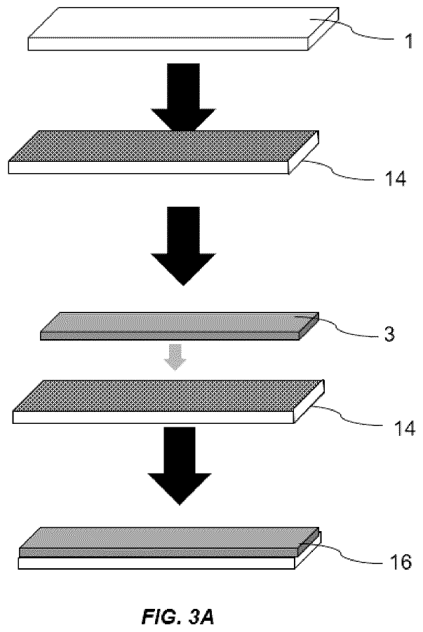

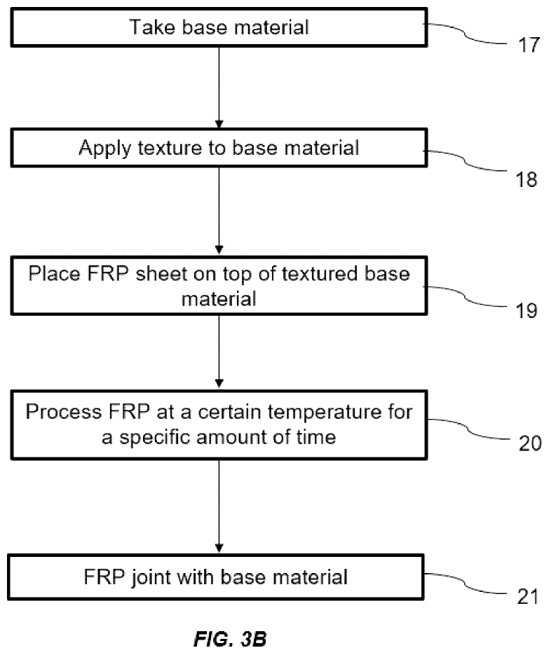

FIG. 3A is a schematic representation of the method of joining of FRP to a base material and creating a laminate by applying a texture on the surface of a base material. A texture 14 is applied to a surface of the base material 1. Embodiments disclosed herein also describe methods to imprint the texture into the base material via squeezing, machining, pressing, forming, knurling, stamping, etching, forging, cutting, rolling, or other imprinting processes as known in the art. The FRP 3 is then placed on top of the base material 14 and heated at a certain temperature for a specific amount of time to cause the polymer matrix to melt and flow into the textures. This process creates a laminate 16 that has the FRP 3 joined to the base material 14. FIG. 3B is a flowchart of the example showing process steps 17, 18, 19, 20, and 21.

The texture 14 may have various configurations, and may be applied to base materials of any dimensions on either or both surfaces of the base material. For example, the textured surface 14 may include a pattern of male (raised) or female (depressed) features, and the features may include without limitation, teeth, knurls, protrusions, depressions, ridges, asperities, “cross-hatches,” parallel or non-parallel lines, star shapes, triangles, hexagons, holes, channels, etc, or a combination of two or more thereof. Thus, the texture may include various features having lines and/or various geometric shapes, arranged in parallel or non-parallel, concentric or non-concentric, and/or overlapping or non-overlapping configurations.

Regardless of the configuration of the textured surface 14, the texture may be provided with an average roughness depth that is capable of providing sufficient volume for the matrix material from the FRP to flow into the texture.

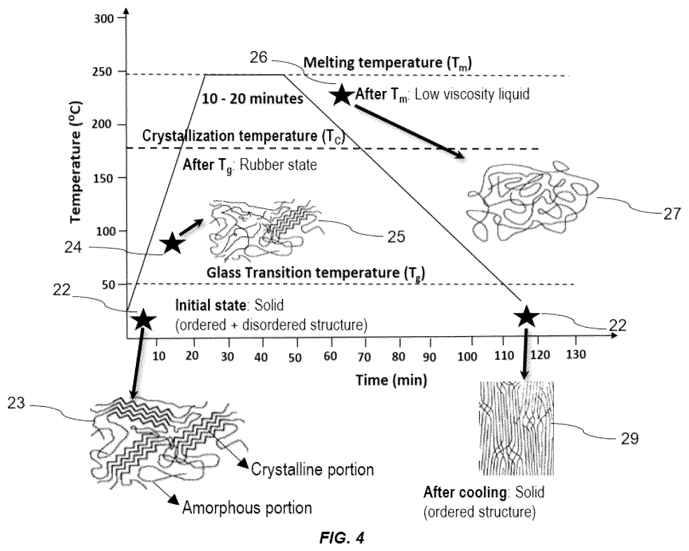

FIG. 4 is a representation of a processing curve for a synthetic resin polymer which is usually chosen as the matrix material for the FRP. However, the matrix could be any other material that meets the performance requirements. At room temperature 22, the matrix material is comprised of a combination of ordered or crystalline structure and disordered or amorphous structure (23). Once the temperature reaches glass transition temperature 24, the matrix turns into a rubber state 25. On further heating, the matrix reaches the melting temperature 26 and forms a low viscosity liquid 27 after it is held at the melting temperature for a certain period of time. At this stage of the process, the matrix material from the FRP in the liquid form flows into the texture applied on the surface of the base material. After flowing into the textures, the matrix (in liquid form) is cooled back to room temperature 22 where it attains the final ordered or crystalline structure 29 due to solidification. At the end of the process, a laminate is created that has the FRP joined to the base material. The final ordered or crystalline structure 29 provides the strength to the laminate 16.

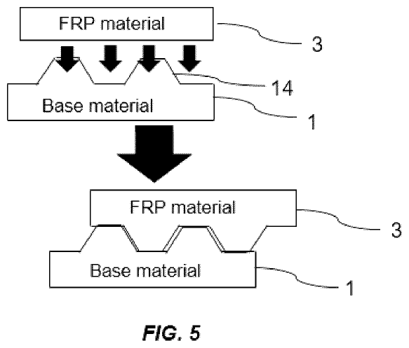

FIG. 5 illustrates schematic exemplary cross-sectional results from the joining operation illustrated in FIG. 3A and FIG. 3B. The matrix from the FRP material 3 melts, flows into and solidifies in the texture 14 applied on the surface of the base material 1 and creates a laminate between the FRP 3 and the base material 1. The texture 14 may have various configurations, and may be applied to base materials of any dimensions. The amount of the matrix from the FRPs that flows into the texture on the base material depends on the volume of the texture available for the matrix to flow into.

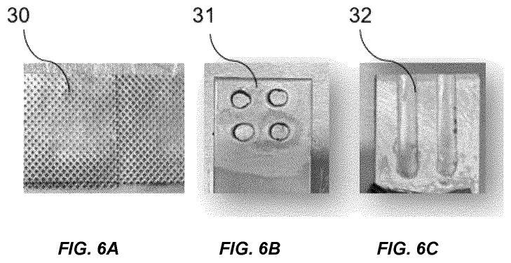

FIGS. 6A, 6B, and 6C represent a few different types of texture that can be applied on the base material. The texture 30 includes a plurality of protruding or depressed pyramids, texture 31 includes a number of holes while texture 32 includes a series of parallel channels of a certain depth and width. However, the texture may be differently configured. For example, the texture may be symmetrical or asymmetrical. Moreover, the texture may be non-randomly distributed on the base material 1 or may instead be randomly distributed on the base material 1. As will be appreciated, the textured surface may be formed via various processes without departing from the present disclosure. For example, the textured surface may be formed via squeezing, machining, pressing, forming, knurling, stamping, etching, forging, cutting, rolling, or other imprinting processes as known in the art.

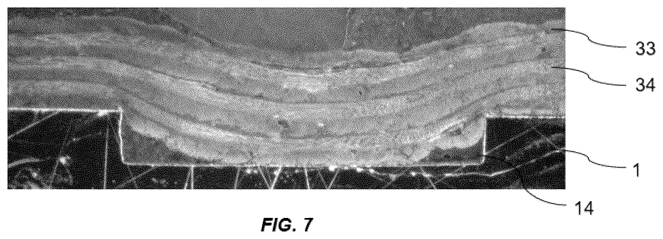

FIG. 7 illustrates the cross-sectional view of a joint after a successful joining process is performed as described above with regard to FIGS. 3A and 3B. After the FRP is processed following the curve illustrated in FIG. 4, the matrix material 33 melts and flows into the texture 14 and solidifies after cooling. The fibers 34 from the FRP are also forced to take the shape of the texture 14 due to the pressure being applied. This results in high amounts of strength for joining the FRP to the base material. FIG. 7 represents a channel of a certain depth and width that is being made in the base material 1 but the texture may be differently configured as well.

Any of the features or attributes of the above described embodiments and variations can be used in combination with any of the other features and attributes of the above described embodiments and variations as desired.

The presently disclosed embodiments provide considerable efficiencies to joining operations, such as cost and time savings. For example, the ability to successfully join dissimilar materials without the use of adhesive or a fastener saves money in most of the applications it is used. The simple, but novel task of removing a fastener from every single joint will give the entity that applies this process an advantage by removing the cost and weight of every single fastener that would traditionally join dissimilar materials together. The lack of a fastener and adhesive gives significant savings over time. This solution also saves impact to the environment as it eliminates the need for adhesives which are not a very environmentally friendly process due to release of contaminants in air, water, and soil.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. The terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A method of joining a Fiber Reinforced Polymer (FRP) to a base material comprising the steps of texturing a first surface of the base material, placing the FRP on the textured surface of the base material, and melting polymer in the FRP and allowing the melted polymer to flow into textures in the textured surface, and cooling the polymer to a solid state to join the FRP to the base material.

2. The method of claim 1, wherein the texture may be applied on one or more additional surfaces of the base material.

3. The method as recited in claim 1, wherein the base material contains a flat or a curved surface.

4. The method of claim 1, wherein a predetermined amount of heat is provided for a predetermined amount of time using a heated platen press to melt the polymer.

5. The method of claim 4, where the press is a mechanical, hydraulic, or pneumatic press.

6. The method of claim 1, the texture is applied on the first surface and a second surface simultaneously or individually.

7. The method of claim 1, wherein the texture comprises a plurality of male or female oriented features

8. The method of claim 7, wherein the plurality of male of female oriented features are selected from the group consisting of knurls, depressions, ridges, asperities, cross-hatches, parallel or non-parallel lines, star shapes, triangles, hexagons, holes, channels, and a combination of two or more thereof.

9. The method of claim 7, wherein plurality of male or female oriented features is arranged in a symmetrical pattern.

10. The method of claim 1, wherein plurality of male or female oriented features is arranged in an asymmetrical pattern.
